(19) United States
(12) Patent Application Publication
(10) Pub. No.: US 2002/0122138 A1
(43) Pub. Date: Sep. 5, 2002

(54) Output information control device and output information control method

(76) Inventor: Masahiro Fukuda, Tokyo (JP)

Correspondence Address: BIRCH STEWART KOLASCH & BIRCH, PO BOX 747, FALLS CHURCH, VA, 22040-0747, US

(21) Appl. No.: 09/977,376

(22) Filed: Oct. 16, 2001

(30) Foreign Application Priority Data
Mar. 5, 2001 (JP) 2001-060024

(51) Int. Cl. H04N 7/00; H04N 5/445

(52) U.S. Cl. 348/564; 348/468

(57) ABSTRACT

An output information control device comprises a display video generation unit for generating a display video signal based on a video signal received together with added information, an associated information storage unit for storing associated information different from the added information, and an information output unit for outputting the associated information stored in the associated information storage unit and the display video signal generated by the display video generation unit while associating them with each other.

### BACKGROUND OF THE INVENTION

1. Field of the Invention

The present invention relates to an output information control device for and output information control device method of, when associated information (e.g., subtitles information) associated with a video signal is transmitted and received together with the video signal, for example, in the case of digital television broadcasting, performing output control on the associated information.

2. Description of the Prior Art

Conventionally, there is a method of defining transmission of subtitles information which is included in BS digital broadcasting operation regulations technical literature (ARIB TR-B15) containing Japanese regulations for digital television broadcasting, as a method for transmitting and receiving both a video signal and subtitles information as information associated with the video signal. According to the regulations, subtitles information can be transmitted by using a transport stream at the same time that image information is transmitted. It is possible to transmit information written in two languages or less as subtitles information.

For example, Japanese patent application publication (TOKKAIHEI) No. 10-234016 discloses a device for performing automatic translation processing on subtitles information which is received together with a video signal so as to produce information on subtitles written in a different language, and for displaying the generated subtitles information together with video received.

Subtitles received can be displayed according to the above-mentioned regulations. On the other hand, subtitles written in a different language which are not included in subtitles information received can be displayed by using the device as disclosed in Japanese patent application publication (TOKKAIHEI) No. 10-234016.

According to the above-mentioned BS digital broadcasting operation regulations, only subtitles written in two languages or less are included in the received subtitles information. One of the reasons why the number of languages used for describing subtitles is limited is that the transmission capacity has a limitation. Therefore, in the case where the subtitles information includes only subtitles written in two languages, it is impossible to address various user needs for display of subtitles written in a different language other than the two languages. On the other hand, in the prior art device that can display information other than information transmitted thereto together with a video signal, as disclosed in Japanese patent application publication (TOKKAIHEI) No. 10-234016, since it takes time to translate subtitles, it is necessary to delay the display of video only by a certain time interval equal to the time required for the translation processing so that the video display can be synchronized with the display of the subtitles. Therefore, the structure of the output information control device becomes complex because of adjustment of the delay, and the real time is lost.

### SUMMARY OF THE INVENTION

The present invention is proposed to solve the above-mentioned problems, and it is therefore an object of the present invention to provide an output information control device and method capable of appropriately outputting associated information (e.g., information on subtitles written in various languages), which is not transmitted thereto together with a video signal received, in synchronization with video generated from the received video signal.

In accordance with an aspect of the present invention, there is provided an output information control device comprising: a display video generation unit for generating a display video signal based on a video signal received together with added information; an associated information storage unit for storing associated information different from the added information; and an information output unit for outputting the associated information stored in the associated information storage unit and the display video signal generated by the display video generation unit while associating them with each other. Accordingly, the output information control device can appropriately output associated information which is not transmitted thereto together with a video signal included in a television broadcast wave, i.e., associated information different from added information obtained by decoding an added information signal included in the television broadcast wave, so that the associated information is synchronized with the received video signal.

In accordance with another aspect of the present invention, the information output unit outputs both the associated information and the display video signal associated with the associated information so that they are synchronized with each other.

In accordance with a further aspect of the present invention, the information output unit combines the associated information and the display video signal so as to produce a composite signal.

In accordance with another aspect of the present invention, the associated information stored in the associated information storage unit is subdivided into a plurality of pieces of information to each of which a number identifying a corresponding part of the display video signal is assigned.

In accordance with a further aspect of the present invention, the output information control device further comprises an added information decoding unit for decoding the added information signal so as to generate the added information, and the information output unit selects and outputs at least one from among the added information generated by the added information decoding unit and the associated information stored in the associated information storing unit.

In accordance with another aspect of the present invention, the output information control device further comprises an information translation unit for translating the associated information stored in the associated information storage unit into translation information written in a different language, and a translation information storage unit for storing the translation information generated by the information translation unit.

In accordance with a further aspect of the present invention, the translation information stored in the translation information storage unit is subdivided into a plurality of pieces of information to each of which a number identifying a corresponding part of the display video signal is assigned.

In accordance with another aspect of the present invention, the information output unit selects and outputs at least one from among the added information generated by the added information decoding unit, the associated information stored in the associated information storing unit, and the translation information stored in the translation information storage unit.

In accordance with a further aspect of the present invention, the output information control device further comprises a communication unit for acquiring the associated information to be stored in the associated information storage unit through bi-directional data communications by way of a communication line.

In accordance with another aspect of the present invention, the output information control device further comprises a reading unit for acquiring the associated information to be stored in the associated information storage unit by reading the associated information from a storage medium.

In accordance with a further aspect of the present invention, there is provided an output information control method comprising the steps of: generating a display video signal based on a video signal received together with an added information signal that carries added information, storing associated information different from the added information, and outputting the stored associated information and the generated display video signal while associating them with each other.

In accordance with another aspect of the present invention, the information output step is the step of outputting both the associated information and the display video signal associated with the associated information so that they are synchronized with each other.

In accordance with a further aspect of the present invention, the information output step is the step of combining the associated information and the display video signal so as to produce a composite signal.

In accordance with another aspect of the present invention, the stored associated information is subdivided into a plurality of pieces of information to each of which a number identifying a corresponding part of the display video signal is assigned.

In accordance with a further aspect of the present invention, the output information control method further comprises the step of decoding the added information signal so as to generate the added information, and the information output step includes the step of selecting and outputting at least one from among the generated added information and the stored associated information.

In accordance with another aspect of the present invention, the output information control method further comprises the steps of translating the associated information into translation information written in a different language, and storing the translation information.

In accordance with a further aspect of the present invention, the translation information is subdivided into a plurality of pieces of information to each of which a number identifying a corresponding part of the display video signal is assigned.

In accordance with another aspect of the present invention, the information output step includes the step of selecting and outputting at least one from among the generated added information, the stored associated information, and the stored translation information.

In accordance with a further aspect of the present invention, the output information control method further comprises the step of acquiring the associated information to be stored through bi-directional data communications by way of a communication line.

In accordance with another aspect of the present invention, the output information control method further comprises the step of acquiring the associated information to be stored by reading the associated information from a storage medium.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing an example of the hardware configuration of an output information control device according to an embodiment of the present invention;

FIG. 2 is a block diagram showing an example of the structure of an entire data information transmission system including the output information control device of the embodiment of the present invention;

FIG. 3 is a diagram showing the data structure of downloaded associated information DD which is stored in an associated information storage unit of the output information control device of the embodiment of the present invention;

FIG. 4 is a diagram showing the data structure of added information RD which is generated from a television broadcast wave by an added information decoder of the output information control device of the embodiment of the present invention; and

FIG. 5 is a diagram showing the data structure of translation information TD which is stored in a translation information storage unit of the output information control device of the embodiment of the present invention.

### DETAILED DESCRIPTION OF THE PREFERRED EMBODIMENT

An output information control device and method according to an embodiment of the present invention can acquire associated information, which is different from added information received via broadcasting together with a video signal, by using another means other than broadcasting, and can output both a display video signal and the associated information while associating them with each other.

Concretely, the output information control device acquires associated information (e.g., subtitles information on subtitles written in a language different from that in which subtitles information received as added information included in a transport stream signal of a television broadcast wave received is written, the former subtitles information being not transmitted and received via the transport stream signal) which is different from the added information (e.g., subtitles information or the like) included in the transport stream signal. The output information control device outputs the acquired associated information and a video signal included in the transport stream signal while associating them with each other.

There can be provided various methods of outputting associated information and a video signal while associating them with each other, such as a method of combining the associated information and a display video signal so as to produce a display image, and a method of outputting the associated information and the display video signal to output devices, respectively, so that they are synchronized with each other. The method of combining associated information and a display video signal so as to produce a display image will be illustrated hereafter. The output information control device combines a video signal and subtitles information associated with the video signal so as to produce a display image.

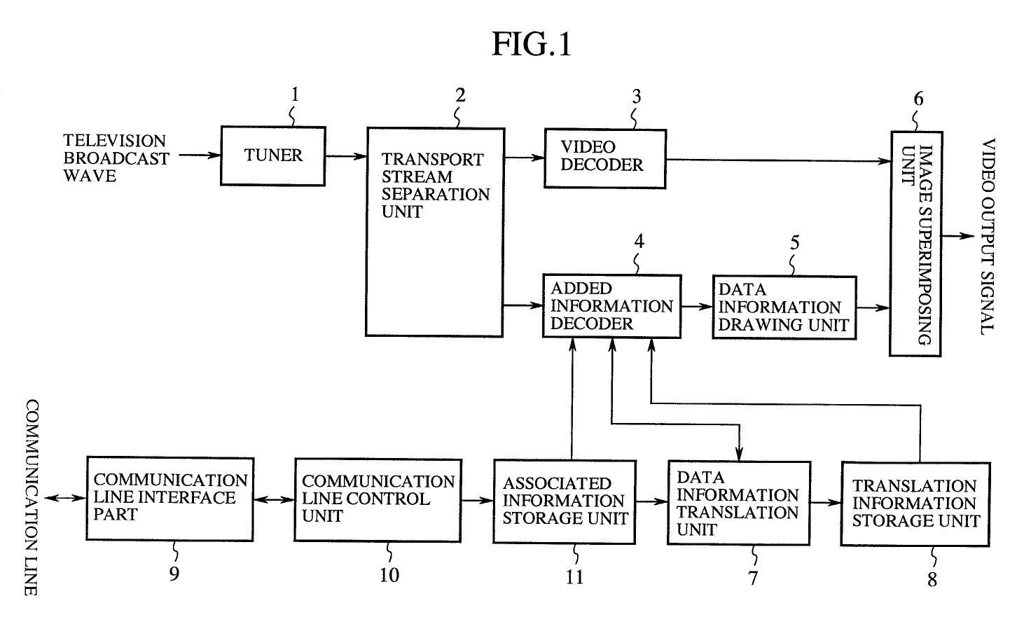

FIG. 1 is a diagram showing one example of the hardware configuration of the output information control device according to the embodiment of the present invention. In the figure, reference numeral 1 denotes a tuner for receiving a television broadcast wave and for performing a channel selection, reference numeral 2 denotes a transport stream separation unit for separating signals associated with a selected electronic program, which are included in a transport stream signal from the tuner 1, into several kinds of signals (a video signal, an added information signal, etc.), reference numeral 3 denotes a video decoder for decoding a transport stream signal for video from the transport stream separation unit 2 so as to produce and output a display video signal, reference numeral 4 denotes an added information decoder for decoding a transport stream signal for added information from the transport stream separation unit 2 so as to produce and output data information (i.e., added information), reference numeral 5 denotes a data information drawing unit for drawing the data information output from the added information decoder 4 on a graphics plane so as to produce and output data information drawing data, reference numeral 6 denotes an image superimposing unit for combining the data information drawing data output from the data information drawing unit 5 and the display video signal output from the video decoder 3 so as to superimpose the data information drawing data upon the video, reference numeral 7 denotes a data information translation unit for translating data information applied thereto into equivalent translation information written in a different language, reference numeral 8 denotes a translation information storage unit for storing the translation information output from the data information translation unit 7, reference numeral 9 denotes a communication line interface unit connected to a communication line, for terminating the communication line and for performing bi-directional transmission of communication signals, reference numeral 10 denotes a communication line control unit for controlling the bi-directional communication performed through the communication line interface unit 9, and reference numeral 11 denotes an associated information storage unit for storing associated information received by way of the communication line.

In operation, the tuner 1 receives a television broadcast wave and is tuned to select a television program which a user desires to watch. The tuner 1 also outputs a transport stream including signals associated with the selected television program to the transport stream separation unit 2. The transport stream separation unit 2 selects and separates the signals associated with the selected television program included in the transport stream output from the tuner 1 into several kinds of signals (a video signal and an added information signal). The transport stream separation unit 2 then outputs a transport stream for the separated video signal to the video decoder 3, and outputs a transport stream for the added information signal to the added information decoder 4.

The video decoder 3 decodes the video signal included in the transport stream for the video signal so as to generate a display video signal, and then outputs the generated display video signal to the image superimposing unit 6. On the other hand, the added information decoder 4 decodes the added information signal included in the transport stream so as to generate added information, and then outputs the generated added information to the data information drawing unit 5.

The data information drawing unit 5 expands the added information generated by the added information decoder 4 to graphics data, and draws it on a graphics plane so as to generate data information drawing data. The data information drawing unit 5 then outputs the generated data information drawing data to the image superimposing unit 6. On the other hand, the image superimposing unit 6 combines the display video signal output from the video decoder 3 and the data information drawing data output from the data information drawing unit 5 so as to generate video with the data information, i.e., to superimpose the data information upon the video, and then outputs the generated video with the data information as a video output signal.

This video output signal output from the image superimposing unit 6 is then input to a monitor, a display, or the like, not shown in the figure. The video with data information can thus be displayed.

In this way, the output information control device can process data information, such as added information which an added information signal or the like included in a television broadcast wave carries, so as to output video with the processed data information.

On the other hand, in order to output data information written in a desired language different from that in which added information which an added information signal included in a received television broadcast wave carries is written, it is necessary to translate the added information into information written in the desired language. When translating the added information, the added information decoder 4 outputs the generated added information to the data information translation unit 7. The data information translation unit 7 then translates the added information generated by the added information decoder 4 into data information written in the desired language. For example, when the data information translation unit 7 has a function of translating data information written in Japanese into equivalent information written in Italian, it can translate the added information written in Japanese which the added information signal carries into equivalent added information written in Italian. The data information translation unit 7 outputs the translated added information (referred to as translation information) to the added information decoder 4. The added information decoder 4 outputs the translation information from the data information translation unit 7 to the data information drawing unit 5 instead of the generated added information. After that, as in the case of the generated added information, the image superimposing unit 6 combines the display video signal output from the video decoder 3 and the data information drawing data output from the data information drawing unit 5 so as to generate video with the data information, and then outputs the generated video with the data information as a video output signal. As a result, the translation information written in Italian, which has not been transmitted via television broadcasting, can be displayed.

However, the translation of data information requires some processing time, and therefore there causes a time lag between the video signal and the translation information. Although to overcome the problem a delay can be introduced to the display video signal output from the video decoder 3, such introduction of a delay into the display video signal when receiving a live broadcast might cause a problem associated with practicality.

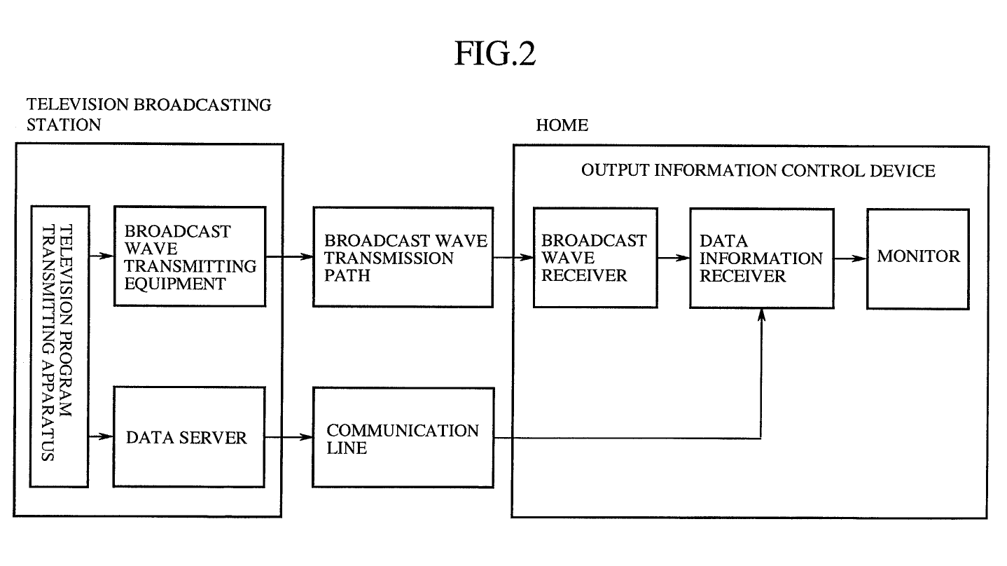

The output information control device according to the embodiment of the present invention has a function of downloading associated information by way of the communication line. Then the output information control device appropriately outputs the associated information by acquiring the associated information in advance by way of the communication line. FIG. 2 is a block diagram showing an example of the structure of an entire data information transmission system including the output information control device according to the embodiment of the present invention. The function of downloading associated information of the output information control device will be explained hereafter with reference to FIG. 2.

To download desired associated information, the communication line control unit 10 establishes a connection with the communication line by way of the communication line interface unit 9. After a connection with the communication line is established, the output information control device accesses a data server for storing associated information different from the added information received together with the video signal. For example, the data server is installed in a television broadcasting station. Associated information associated with each television program has already been stored in the data server before the start time of each television program. The associated information is separated into several pieces of information written in different languages and they are stored in the data server. The communication line control unit 10 can make a request of the data server for a piece of associated information written in a desired language so as to download the piece of associated information from the data server. When the communication line control unit 10 makes a request of the data server for a piece of associated information written in a desired language by way of the communication line interface unit 9, the data server disposed within the television broadcasting station transmits the desired associated information to the communication line interface unit 9 by way of the communication line. The communication line interface unit 9 transmits the received associated information to the communication line control unit 10, and the communication line control unit 10 stores the received associated information in the associated information storage unit 11. The output information control device can thus download the desired associated information from the data server.

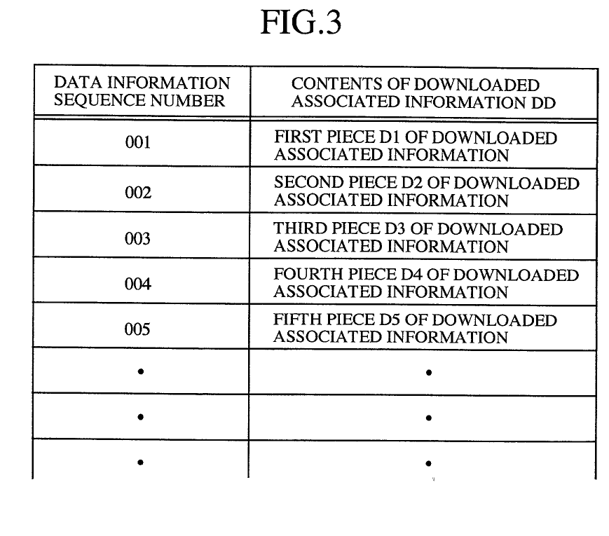

FIG. 3 is a diagram showing the data structure of associated information DD which is downloaded from the data server and is stored in the associated information storage unit 11. The downloaded associated information DD is subdivided into a plurality of pieces each of which consists of “data information sequence number” and “part of the contents of the downloaded associated information DD”. In other words, a data information sequence number is assigned in sequence to each of the plurality of pieces of data information into which the downloaded associated information DD is subdivided so that they are associated with frames of the video, respectively. Data information sequence number “001” is assigned to the first piece of data information D1 of the downloaded associated information DD shown in FIG. 3, and data information sequence numbers: “002”, “003”, . . . which sequentially increase one by one are assigned to remaining pieces of data information D2, D3, and . . . , respectively.

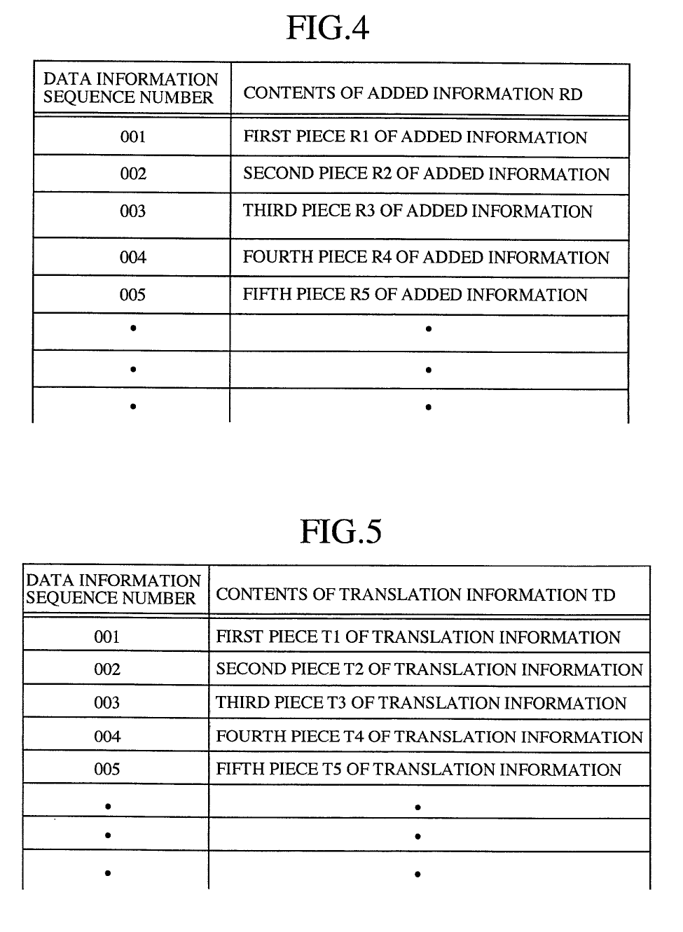

On the other hand, when a television program is broadcast, the added information decoder 4 decodes an added information signal included in the television broadcast wave so as to generate added information RD. FIG. 4 is a diagram showing the data structure of the added information RD generated from the television broadcast wave. The added information RD is subdivided into a plurality of pieces each of which consists of “data information sequence number” and “part of the contents of the added information RD”. A data information sequence number is assigned in sequence to each of a plurality of pieces of data information into which the added information RD is subdivided so that they are associated with frames of the video, respectively, as in the case of the downloaded associated information DD (see FIG. 3). Data information sequence number “001” is assigned to the first piece of data information R1 of the added information RD shown in FIG. 4, and data information sequence numbers: “002”, “003”, . . . which sequentially increase one by one are assigned to remaining pieces of data information R2, R3, and . . . , respectively.

When outputting information written in a language which is not included in the television broadcast wave, the output information control device uses associated information DD downloaded in advance instead of the added information RD included in the television broadcast wave. The added information decoder 4 retrieves corresponding associated information DD from the associated information storage unit 11 and uses it instead of the added information RD. To be more specific, for example, the added information decoder 4 retrieves the third piece D3 of downloaded associated information with a corresponding data information sequence number (in this case, 003) from the added information storage unit 11 and uses the third piece D3 of downloaded associated information at the time when using the third piece R3 of added information generated from the television broadcast wave, instead of the third piece R3 of added information. In other words, the added information decoder 4 delivers the third piece D3 of associated information retrieved from the associated information storage unit 11 to the data information drawing unit 5 as data information. After that, the output information control device operates in the same way that it does in the case of delivering data information such as added information which the added information signal included in the television broadcast wave carries. In this way, the output information control device can output data information written in a language which is not included in the television broadcast wave by using associated information DD downloaded in advance.

Although the data server disposed within the television broadcasting station in FIG. 2 can store data information written in a larger number of languages than the number of languages which can be provided by the data information included in the television broadcast wave, there is a possibility that data information written in a desired language cannot be found in the data server. In such a case, the output information control device can generate data information written in a desired language by translating the downloaded associated information DD.

FIG. 5 is a diagram showing the data structure of translation information TD which is stored in the translation information storage unit 8. The translation information TD is subdivided into a plurality of pieces each of which consists of “data information sequence number” and “part of the contents of the translation information TD”. A data information sequence number is assigned in sequence to each of a plurality of pieces of data information into which the translation information TD is subdivided so that they are associated with frames of the video, respectively, as in the case of the downloaded associated information DD (see FIG. 3). Data information sequence number “001” is assigned to the first piece of data information T1 of the translation information TD shown in FIG. 5, and data information sequence numbers: “002”, “003”, . . . which sequentially increase one by one are assigned to remaining pieces of data information T2, T3, and . . . , respectively.

The associated information storage unit 11 outputs associated information DD which has been downloaded thereto and is stored therein to the data information translation unit 7. The data information translation unit 7 translates the contents of the associated information DD into data information (i.e., translation information TD) written in a different language, and then stores the translation information obtained from the translation of the contents of the associated information DD in the translation information storage unit 8. In this case, the data information translation unit 7 stores the translation information TD in the translation information storage unit 8 while associating all data information sequence numbers respectively assigned to all pieces of the downloaded associated information DD which have not been translated yet with all pieces of the translation information TD, respectively, as shown in FIG. 5.

The data information translation unit 7 performs the above-mentioned translation before the corresponding television program is broadcast. When the television program is broadcast, the added information decoder 4 decodes the added information signal included in the television broadcast wave, and reads the translation information TD stored in the translation information storage unit 8 at the time when generating added information. To be more specific, for example, the added information decoder 4 retrieves the third piece of translation information T3 with a corresponding data information sequence number (in this case, 003) from the translation information storage unit 8 and uses the third piece of translation information T3 at the time when using the third piece of added information R3 generated from the television broadcast wave, instead of the third piece of added information R3. In other words, the added information decoder 4 outputs the third piece of translation information T3 retrieved from the translation information storage unit 8 to the data information drawing unit 5 as data information. After that, the output information control device operates in the same way that it does in the case of delivering data information such as added information which the added information signal included in the television broadcast wave carries.

In this way, the output information control device can output data information written in a language which is not provided by the television broadcasting station by using translation information TD into which associated information downloaded in advance is translated. Since before the broadcast time for any television program, it is possible to download data information on the television program and translate added information into translation information written in a different language and to store them in a storage unit, it is possible to output either the downloaded data information or the translation information at the same time that the television program is broadcast even when much time is spent in either of the downloading and the translation processing.

The above-mentioned operation can be implemented via hardware, or can alternatively be implemented via software.

As mentioned above, in accordance with the above-mentioned embodiment of the present invention, the output information control device can download associated information different from added information, which is obtained by decoding an added information signal included in a television broadcast wave, by way of a communication line so as to output the associated information written in a different language which is not included in the television broadcast wave.

Numerous variants may be made in the exemplary embodiment shown. Instead of downloading associated information different from added information, which is obtained by decoding an added information signal included in a television broadcast wave, by way of a communication line, the output information control device can read the associated information from a storage medium, such as a CD-ROM disc, an MO disc, or a DVD disc. For example, when a user watches a television program, the output information control device can read information associated with the television program from a CD-ROM disc which the user purchased in advance. In other words, all the output information control device has to do is to acquire associated information to be provided for the user while associating the associated information with a corresponding video signal, and therefore the present invention is not limited to the above-mentioned method.

Instead of combining associated information and a video signal so as to associate the associated information with the video signal by means of the image superimposing unit and displaying a composite image on a display, the output information control device can output the associated information and a display video signal to separate displays so that they are synchronized with each other. For example, the output information control device can output the display video signal to a display such as a CRT, and can also output the associated information (e.g., subtitles information) to another display such as a small liquid crystal display so that the video and the corresponding associated information are displayed in synchronization with each other. In other words, all the output information control device has to do is to acquire associated information to be provided for the user while associating the associated information with a corresponding video signal, and therefore the present invention is not limited to the above-mentioned structure.

The associated information is associated with the video information, and is not limited to information on translated sentences. As an alternative, the associated information can be information that needs to be output together with the video information, such as characters (explanation, data, or the like), pictures (illustration, images, or the like), or sounds.

Since the output information control device can perform translation processing and acquisition of associated information by downloading it thereinto before the broadcast time for a corresponding television program, the output information control device can output appropriate associated information matched to the corresponding video signal without performing complex control such as adjustment of a delay to be introduced to the video display according to the time required for the translation processing which is conventionally performed at the broadcast time for the television program and without losing the real time.

The present invention is not limited to the wireless television broadcasting system that receives a television broadcast wave and outputs associated information different from added information obtained by decoding an added information signal included in the television broadcast wave. As an alternative, the present invention can be applied to a broadcasting system, such as a cable broadcasting system (e.g., a cable television broadcasting system), that simply can output information associated with video, which is not transmitted together with the video signal sent via the broadcasting.

Many widely different embodiments of the present invention may be constructed without departing from the spirit and scope of the present invention. It should be understood that the present invention is not limited to the specific embodiments described in the specification, except as defined in the appended claims.

What is claimed is:

1. An output information control device comprising:
a display video generation means for generating a display video signal based on a video signal received together with added information;
an associated information storage means for storing associated information different from the added information; and
an information output means for outputting the associated information stored in said associated information storage means and the display video signal generated by said display video generation means while associating them with each other.

2. The output information control device according to claim 1, wherein said information output means outputs both the associated information and the display video signal associated with the associated information so that they are synchronized with each other.

3. The output information control device according to claim 1, wherein said information output means combines the associated information and the display video signal so as to produce a composite signal.

4. The output information control device according to claim 1, wherein the associated information stored in said associated information storage means is subdivided into a plurality of pieces of information to each of which a number identifying a corresponding part of the display video signal is assigned.

5. The output information control device according to claim 1, further comprising an added information decoding means for decoding the added information signal so as to generate the added information, wherein said information output means selects and outputs at least one from among the added information generated by said added information decoding means and the associated information stored in said associated information storing means.

6. The output information control device according to claim 1, further comprising an information translation means for translating the associated information stored in said associated information storage means into translation information written in a different language, and a translation information storage means for storing the translation information generated by said information translation means.

7. The output information control device according to claim 6, wherein the translation information stored in said translation information storage means is subdivided into a plurality of pieces of information to each of which a number identifying a corresponding part of the display video signal is assigned.

8. The output information control device according to claim 6, wherein said information output means selects and outputs at least one from among the added information generated by said added information decoding means, the associated information stored in said associated information storing means, and the translation information stored in said translation information storage means.

9. The output information control device according to claim 1, further comprising a communication means for acquiring the associated information to be stored in said associated information storage means through bi-directional data communications by way of a communication line.

10. The output information control device according to claim 1, further comprising a reading means for acquiring the associated information to be stored in said associated information storage means by reading the associated information from a storage medium.

11. An output information control method comprising the steps of: generating a display video signal based on a video signal received together with an added information signal that carries added information, storing associated information different from the added information, and outputting the stored associated information and the generated display video signal while associating them with each other.

12. The output information control method according to claim 11, wherein said information output step is the step of outputting both the associated information and the display video signal associated with the associated information so that they are synchronized with each other.

13. The output information control method according to claim 11, wherein said information output step is the step of combining the associated information and the display video signal so as to produce a composite signal.

14. The output information control method according to claim 11, wherein the stored associated information is subdivided into a plurality of pieces of information to each of which a number identifying a corresponding part of the display video signal is assigned.

15. The output information control method according to claim 11, further comprising the step of decoding the added information signal so as to generate the added information, wherein said information output step includes the step of selecting and outputting at least one from among the generated added information and the stored associated information.

16. The output information control method according to claim 11, further comprising the steps of translating the associated information into translation information written in a different language, and storing the translation information.

17. The output information control method according to claim 16, wherein the translation information is subdivided into a plurality of pieces of information to each of which a number identifying a corresponding part of the display video signal is assigned.

18. The output information control method according to claim 16, wherein said information output step includes the step of selecting and outputting at least one from among the generated added information, the stored associated information, and the stored translation information.

19. The output information control method according to claim 11, further comprising the step of acquiring the associated information to be stored through bi-directional data communications by way of a communication line.

20. The output information control method according to claim 1, further comprising the step of acquiring the associated information to be stored by reading the associated information from a storage medium.
